(19) United States
(12) Patent Application Publication
(10) Pub. No.: US 2022/0195793 A1
(43) Pub. Date: Jun. 23, 2022

(54) BLADES OF FIXED SUNSHADE DEVICES, AND METHOD AND DEVICE FOR MANUFACTURING SAME

(71) Applicant: Les Ingénieurs du Soleil, Ramonville Saint Agne (FR)

(72) Inventor: Xavier Sembely, Toulouse (FR)

(73) Assignee: Les Ingénieurs du Soleil, Ramonville Saint Agne (FR)

(21) Appl. No.: 17/604,148

(22) PCT Filed: Apr. 17, 2020
(86) PCT No.: PCT/EP2020/060828

§ 371 Date: Oct. 15, 2021

(30) Foreign Application Priority Data
Apr. 19, 2019 (FR) FR1904242

(51) Int. Cl. E06B 9/28; B21D 53/00

(52) U.S. Cl. CPC E06B 9/28; E06B 2009/2482; B21D 53/00

(57) ABSTRACT

The invention relates to a blade of a brise-soleil device, said blade being noteworthy in that it is produced in one piece comprising: substantially planar elongate, separate and parallel solid lamellae, discontinuous cutouts separating the solid lamellae, connecting spacers providing connection and spacing between solid lamellae, said cutouts being enclosed by the edges of the lamellae and the edges of the connecting spacers. The invention also relates to a method and a device for manufacturing such a blade.

### TECHNICAL FIELD

The invention is concerned with the field of sunshade devices and especially to adaptations making it possible to manufacture the blades making up said devices in the best conditions.

### BACKGROUND

Solar protection of a building conventionally involves blinds, whether they are positioned outside of the building (adjustable sunshades), or integrated into the windows and openings, or inside the building (Venetian blinds).

The blades of these blinds are generally of a nearly planar shape with a curvature widthwise of a radius significantly greater than the width of the blade, and generally oriented downwards, that is with the center of curvature below the blade. This curvature gives the blades the rigidity required to be carried only by spaced cable ladder systems.

Nearly all of these blind systems are movable and rotation of the blades can be controlled by the building user, or by an automatic blade opening management system.

However, there are applications where the blinds are fixed and applications where the blinds are fixed and tilted. Document W02017017353 describes especially the latter type of system.

Nevertheless, since these blinds are fixed, the drawback of the use of blades with conventional profiles is that these profiles strongly favor the direction of transparency (parallel to the blades), and are substantially opaque in the directions away from the direction of transparency. This is a visual discomfort for the user of the building, all the more annoying as the blind cannot be raised. There are non-tilted fixed blinds that consist of blades formed by openwork metal sheets and extended so as to have disjointed solid surfaces oriented substantially perpendicular to the direction of the sun in summer and openings allowing a vision through the blade in addition to the openings formed by the space separating blades.

According to patent W02017017353, the overall geometry of the blind ensures that the direction of the winter sun projected in the sectional plane of the blades is substantially parallel to the direction of opening of the blind, and that the direction of the summer sun projected in the sectional plane is close to 45° from the direction of opening of the blind.

This particular property makes it possible to choose to divide a blade into at least two disjointed elongated surfaces, and to arrange each of these surfaces in a direction close to the perpendicular to the direction of the sun in summer—the only direction where opacity is really sought. Nevertheless, making blades with said disjointed surfaces is complex.

Indeed, although it is possible to manufacture large elongated slats and to attach them to each other by maintaining a gap to form a blade, such a manufacturing method requires a multiplication of parts and a high accuracy in making and angularly positioning the latter.

By contrast, the extension of openwork metal sheets does not allow large elongated slats to be obtained, which is detrimental to the aesthetics and to the ability to see through the obtained blades. Moreover, the orientation of the surfaces obtained after extension is not particularly accurate.

### SUMMARY

Based on this fact, the applicant has conducted research aimed at simplifying the manufacture of blinds and fixed sunshade devices.

This research has led to the design and production of blades with a configuration and geometry that facilitate industrialization of their manufacture and therefore of the blinds and fixed sunshade devices of which they are a part.

Thus, the manufacture of said blades of blinds or fixed sunshade devices in industrially viable conditions is one object of the invention.

According to the invention, the fixed sunshade device blade is remarkable in that it is made as a single piece comprising:

solid slats that are substantially planar, elongated, disjointed and parallel,

discontinuous recesses separating the solid slats,

connecting braces ensuring connection and bracing between the solid slats, said recesses being framed by the edges of the blades and the edges of the connecting braces.

A one-piece configuration facilitates the manufacture of the blade in that the slats and the positioning parts are manufactured at the same time. It is no longer necessary to handle multiple parts and ensure their accurate manufacture and positioning. It is also no longer necessary to plan an operation of assembling the parts constituting a single blade.

Moreover, the manufacture of blades formed by elongated slats will allow an aesthetics consistent with the one of the conventional blinds.

As the blades are in a one-piece configuration, the blinds and the sunshade device that they form are much easier to assemble and manufacture.

According to a first one-piece configuration of the invention, the blade is remarkable in that the longitudinal edges of the slats form continuous ridges, the discontinuous recesses are aligned between the slats and the connecting braces connect the adjacent edges of said slats.

According to another particularly advantageous characteristic of the invention, the blade is remarkable in that the braces separating the same two slats are coplanar, the plane in which the braces separating and connecting the same two slats are positioned being different from that of the slats, the planes in which the slats are positioned being parallel to each other and those in which the braces are positioned being parallel to each other.

According to a preferred but non-limiting embodiment, the blade thus formed adopts an accordion shape where one fold out of two is formed by solid slats and where the second fold is formed by aligned recesses framed by the edges of the slats and by the edges of the braces. In accordance with the principles of this type of blade, solid slats are oriented to ensure opacity to solar radiation and recesses are oriented to allow vision through the blade.

According to another particularly advantageous characteristic of the invention, the blade is remarkable in that the braces and thus the recesses that they frame are aligned from one pair of slats to another.

According to another particularly advantageous characteristic of the invention, the blade is remarkable in that the braces and thus the recesses which they frame are offset from one pair of slats to another.

According to another one-piece configuration of the invention, the slats each consist, in projection, of a succession of elongated, coplanar parallelograms, said parallelograms being connected to each other by a portion of their long length and offset from each other by a long portion of their length.

The longitudinal edges of the slats then form discontinuous ridges.

Each slat consists of n parallelograms rigidly connected to each other at their ends. The braces ensure connection between the slats.

According to a preferred but non-limiting embodiment, the parallelograms following one another in an offset manner in a same plane while remaining joined at a portion of their longitudinal rim or long side, form rectangular portions.

According to another particularly advantageous characteristic of the invention, the blade is remarkable in that said braces separating the same two blades are parallel and non-coplanar.

According to another particularly advantageous characteristic of the invention, the blade is remarkable in that the slats are parallel to each other and offset, the brace projecting from a short side of a parallelogram of a first slat joining the opposite short side of another parallelogram of an adjacent slat.

The plurality of slats are then connected to each other by a succession of braces connecting the short sides of said parallelograms of one slat with the opposite short sides of the parallelograms of the next slat.

The blade thus formed adopts a staircase shape with the slats and braces offset. The slats are formed by a plurality of parallel offset planar portions separated by equally offset recesses. Nevertheless, as for the previous configuration, the solid slats are oriented to ensure opacity to solar radiation and the recesses are oriented to allow vision through the blade.

The invention also relates to the sunshade device and the blind manufactured from such blades. The invention especially relates to a sunshade device or blind for a planar surface of a building composed of a series of blades or lamellar structures as described above, which are parallel overall and cover the whole or a large part of said surface, where each blade or lamellar structure is tilted longitudinally substantially parallel to the axis defined as the intersection of the plane of said surface and the plane of the earth's equator as seen from said building.

The invention also relates to a sunshade device or blind formed from the above-described blades or lamellar structures and integrated into the space separating glazing of a glazed surface.

These configurations can be manufactured by molding, stamping, folding, etc.

These two configurations have the advantage that they can be obtained by a method using a planar raw material that is as thin as possible, possibly packaged in the form of a ribbon.

According to a preferred but non-limiting embodiment, the ribbon is an aluminum ribbon.

According to a preferred but non-limiting embodiment, the ribbon is an aluminum ribbon of 200 μm thickness and 17.5 mm width.

For example, according to a first technical solution, the method is remarkable in that the blade is made from a planar ribbon forming a flat profile, the material between two longitudinal planar portions is removed to form aligned elongated ports separated by portions of material, and then the ribbon is shaped into an accordion-like shape, the folds being longitudinal. The accordion folded shape widthwise of the blade provides rigidity to the blade lengthwise. The material removal and shaping operations can be done in either order, each solution having advantages and drawbacks.

It is understood that the blade obtained by this method corresponds to the first configuration by having disjointed elongated planar portions connected to each other by regularly distributed connecting portions of material lengthwise so that the elongated planar portions of material are rigidly held together. The portions of material used for connection have the width of the ports they separate.

However, if the first configuration is manufactured by material removal, the method defines a material loss at the recesses.

The geometry of the second configuration is optimized to avoid this material loss.

According to a particularly advantageous characteristic, the method for obtaining said second configuration is remarkable in that the blade is manufactured from a planar ribbon forming a flat profile, on which parallel series of aligned elongated longitudinal slots are made iteratively and at a determined pitch, separated by portions of material to separate parallel longitudinal planar portions, the slots of one series being offset lengthwise, said longitudinal planar portions then being deformed, the deformation creating a brace and at the slots, an opening forming a recess between the longitudinal planar portions belonging to different alignments and forming the slats.

The pitch corresponds substantially to the long length of the parallelogram.

Such a method avoids material removal and the management of this removal by providing a slot. This slot will make it possible to separate longitudinal portions by folding along a transverse fold. This folding will create the space necessary for the passage of light between the longitudinal portions of the flat profile, which are opaque. It is understood that the offset has to be regular and constant.

Such a method provides an industrial manufacture of sunshade blade consisting in providing an innovative blade profile, allowing the blades to be significantly opaque in a set of directions favorable to the function of solar protection and to be significantly transparent in the directions away from it, while remaining manufacturable at a lesser cost.

Indeed, the planar longitudinal portions and openings obtained by the method will serve respectively for opacity and transparency.

According to a preferred but non-limiting embodiment, the deformation is implemented by folding.

It is understood that the blade obtained by this method is the blade adopting the second configuration, the longitudinal elongated surfaces are connected to each other by (non-slit) portions of material disposed lengthwise. This solution can only be understood if a minimum of two patterns are produced lengthwise. The blade thus has successive offsets to provide said portions of material.

According to another particularly advantageous characteristic of the invention, the method is remarkable in that it comprises an iterative shaping operation by means of jaws on the coplanar zones containing all the elongated surfaces occurring in the same plane in the final state, one set of jaws taking this coplanar zone, and another set of jaws taking the adjacent coplanar zone. Relative movement of the two sets of jaws is then engaged in order to perform plastic deformation of the material at the ends of the portions of material connecting one zone to the other.

According to a preferred but non-limiting embodiment, the method further comprises an operation of punching the deformed ribbon to finalize the shape of the blade.

According to another particularly advantageous characteristic of the invention, an iterative operation of incising the ribbon of material, is implemented upstream of shaping, that is upstream of the set of jaws. This avoids accumulation of incision positioning errors as the iterative shaping process proceeds.

According to another particularly advantageous characteristic of the invention, the incision operation is performed simultaneously with the plastic deformation operation. Such an operation is in particular adapted for groups of rotatable jaws.

According to another particularly advantageous characteristic of the invention, no prior incision is made in the material, the openings and separation being made by tearing between the zones gripped in the jaws.

The invention also relates to the device for implementing said method.

According to a particularly advantageous characteristic of the invention, the device is remarkable in that it comprises at least one set of rotatable jaws synchronously rotating between which a portion of the flat profile is disposed widthwise, whether or not previously incised, said jaws being disposed in pairs at different positions to come into contact on different portions of the width of the blade, the pairs of jaws being offset from each other so as to reproduce the gap of the slats, said jaws adopting a profile with at least one spiral, the difference in radius between the beginning and the end of the spiral forming a planar step ensuring deformation of the planar portions of the slats to form the braces.

This device is remarkable in that it allows the deformations to be carried out for all the braces connecting two slats at the same time. For this reason, the rotatable jaws are synchronous.

According to another particularly advantageous characteristic, the device comprises a set of form and counter-form between which the deformed ribbon passes in order to implement a punching operation.

According to another particularly advantageous characteristic of the invention, the device is remarkable in that it comprises at least one set of jaws between which the flat profile passes, whether or not previously incised.

The fundamental concepts of the invention having just been set out above in their most basic form, other details and characteristics will become clearer upon reading the following description and in relation to the appended drawings, showing, by way of non-limiting example, several exemplary embodiments of a method, a device and blades in accordance with the invention.

### BRIEF DESCRIPTION OF THE DRAWINGS

FIG. 1 is a schematic drawing of a perspective view of a first embodiment of a blade in accordance with the invention;

FIG. 2 is a schematic drawing of a partial perspective view of a second embodiment of a blade in accordance with the invention;

FIG. 3 and

FIG. 4 are schematic perspective drawings of different positions of a device for manufacturing a blade also having the configuration shown in FIG. 2;

FIG. 5 and

FIG. 6 are top view schematic drawings of a blade being manufactured and finalized by the device of FIGS. 3 and 4, respectively.

### DETAILED DESCRIPTION

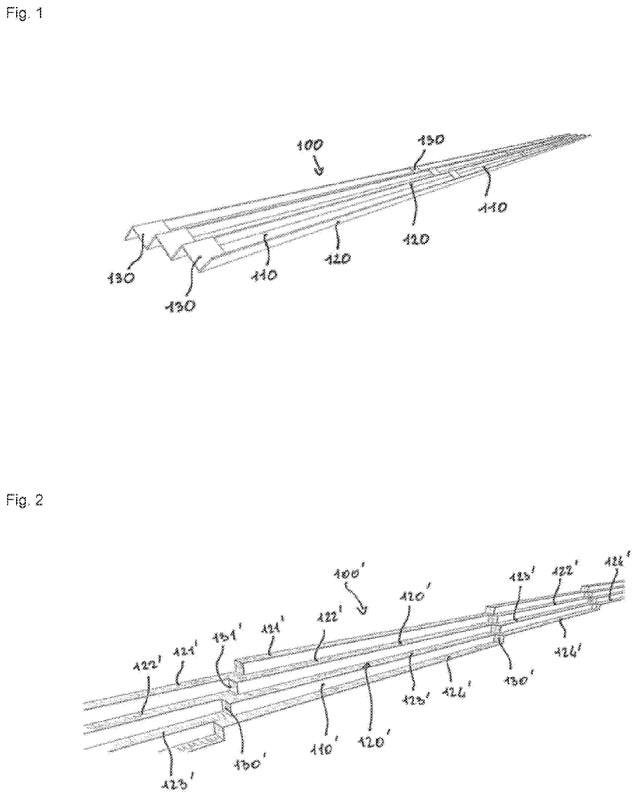

As illustrated in the drawing of FIG. 1, the blade 100 of the sunshade device (not illustrated) adopts the shape of an accordion folding and is made from a flat profile preformed by several operations so as to have opaque sunshade parts and, between these parts, openwork parts allowing light to pass therethrough.

The embodiment of the blade 100 comprises, before folding, a material removal operation for the purpose of making several series of longitudinal aligned elongated recesses or ports 110 in the flat profile for the purpose of separating substantially planar longitudinal portions of material or slats 120. Said ports 110 of a same alignment are separated on a same series by portions of material or braces 130 which adopt the width of the ports 110. These braces 130 ensure the transverse connection and gap between the planar longitudinal portions of material 120.

The accordion folding is made by using the longitudinal edges of the longitudinal portions 120 of material as a folding line. This folding causes a change of planes of said separate planar longitudinal portions 120, which remain connected by said portions of material 130.

The longitudinal portions 120 of material remain substantially planar after folding and are parallel to each other. Similarly, the transverse connecting portions 130 also remain planar and are parallel to each other or coplanar (if located in the same alignment of openings 110).

The angle of the folding and the angle of positioning of the blade 100 make it possible to meet criteria defined to make up the desired sunshade, namely solid parts for opacity and recessed parts to allow vision through the blade.

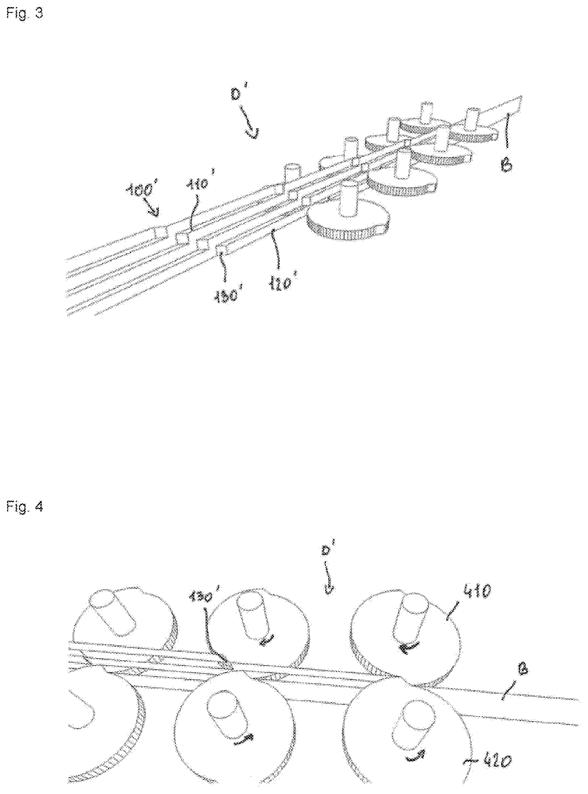

The drawing of FIG. 2 illustrates another embodiment of a blade 100′ for a sunshade device (not illustrated) which has the advantage of not requiring a material removal while providing, from a flat profile, opaque sunshade parts and, between the latter, openwork parts allowing light to pass therethrough, as in the previous embodiment.

The blade 100′ is made from a planar ribbon forming the flat profile, parallel series of aligned elongated slots separated by connecting portions of material or braces 130′ are made to separate aligned longitudinal planar portions or slats 120′. The slots in one series with respect to the other are offset lengthwise so that the braces 130′ are also offset both longitudinally in a same alignment and transversely.

Indeed, said longitudinal planar portions 120′ are deformed at the connecting braces 130′ so as to create an opening 110′ between the longitudinal planar portions 120′ belonging to different alignments. This deformation by folding consists in offsetting said longitudinal planar portions 120′ by folding said connecting portions of material 130′.

The edges of the slats 120′ form discontinuous ridges by each consisting, in projection, of four coplanar rectangular portions 121′, 122′, 123′, 124′ by being connected to each other but by being offset from one rectangular portion to the other, at the end by their long side, the short sides receiving the connecting braces 130′ to make the connection with an adjacent slat 120′. Indeed, for example, the brace 131′ projects from one short side of the rectangular portion 122′ of a first slat 120′ and connects to the opposite short side of another rectangular portion 122′ of an adjacent slat 120′.

As illustrated, said braces 130′ separating the same two slats 120′ are parallel and non-coplanar.

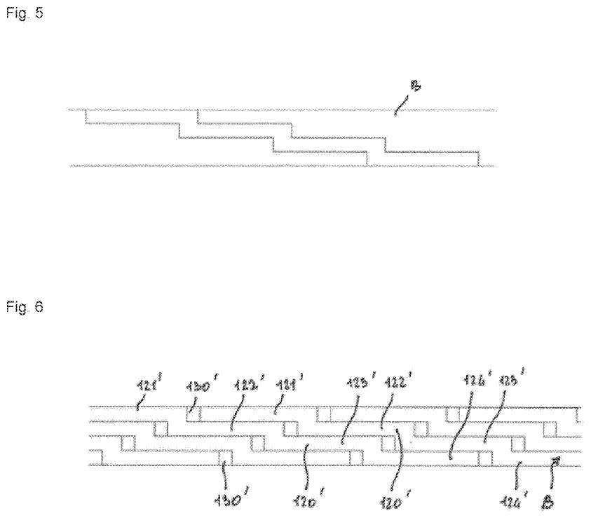

A manufacturing device D′ has been designed and is illustrated by the drawings in FIGS. 4 and 5. Work is made in iso-planes. Surfaces that are strictly in the same plane are offset by one pattern lengthwise. Next, moving jaws are replaced by a series of jaws profiled in the unwinding direction that rotate together and are offset both lengthwise and widthwise.

In this device D′, a metal strip B passes through a series of rotatable jaws. These rotatable jaws are disposed in pairs, each pair being positioned at a different height. The height of the jaw corresponds to the thickness of the elongated planar portions or slats 120′ of the blade 100′.

The drawing in FIG. 5 illustrates the pattern produced by rotating the rotatable jaws. The longitudinal lines are slots and the transverse lines correspond to folds. When the rotation is continued, the pattern is repeated as illustrated in the drawings of FIG. 6, in which the slats 120′ composed of the rectangular parallelograms 121′, 122′123′, 124′ which are adjacent to each other can be distinguished since it is a top view.

The four pairs of jaws make it possible to make the blade 100′ which has four solid slats 120′ and 3 series of ports or recesses 110′ (see FIG. 2).

As illustrated, the jaws are not circular-curve cylinders. Their external surface adopts a symmetrical double spiral curve that bears against the material of the strip B. A first spiral curve starts at the bottom of the end of the second spiral, creating a planar step that, coming into correspondence by rotation with the symmetrical step of the rotatable jaw of the same pair, ensures deformation of the strip by forming the fold corresponding to the brace 130′.

The incision may have been made during or prior to the rotation of said jaws.

It is understood that the method, device and blades, have just been described and represented above, for the sake of disclosure rather than limitation. Of course, various adjustments, modifications and improvements may be made to the above examples without departing from the scope of the invention.

1-9. (canceled)

10. A blade of a fixed sunshade device, the blade being made as a single piece comprising:
solid slats that are substantially planar, elongated, disjointed and parallel,
discontinuous recesses separating the solid slats,
connecting braces ensuring connection and bracing between solid slats,
said recesses being framed by the edges of the slats and the edges of the connecting braces.

11. The blade of a fixed sunshade device according to claim 10, wherein the longitudinal edges of the slats form continuous ridges, the discontinuous recesses are aligned between the slats and the connecting braces connect the adjacent edges of said slats.

12. The blade of a fixed sunshade device according to claim 10, wherein the braces separating the same two slats are coplanar,
the plane in which the braces separating and connecting the same two slats are positioned being different from that of the slats, the planes in which the slats are positioned being parallel to each other and those in which the braces are positioned being parallel to each other.

13. The blade of a fixed sunshade device according to claim 10, wherein the braces, and therefore the recesses which they frame, are aligned from one pair of slats to another.

14. The blade of a fixed sunshade device according to claim 10, wherein the braces, and therefore the recesses that they frame, are offset from one pair of slats to another.

15. The blade of a fixed sunshade device according to claim 10, wherein the slats each consist, in a projection, of a succession of elongated, coplanar parallelograms, said parallelograms being connected to each other by a portion of their long length and offset from one another in the direction of their long length.

16. The blade of a fixed sunshade device according to claim 15, wherein the slats are parallel to each other and offset, the brace projecting from one short side of a parallelogram of a first slat connecting to the opposite short side of another parallelogram of an adjacent slat.

17. A method for manufacturing the blade of a fixed sunshade device according to claim 15, wherein the blade is manufactured from a planar ribbon forming a flat profile on which parallel series of aligned elongated longitudinal slots separated by portions of material are made iteratively and at a determined pitch to separate parallel longitudinal planar portions, the slots of one series with respect to the other being offset lengthwise,
said longitudinal planar portions then being deformed, the deformation creating a brace and at the slots, an opening forming a recess between the longitudinal planar portions belonging to different alignments and forming the slats.

18. The device for implementing the method of claim 17, comprising at least one set of rotatable jaws synchronously rotating, between which a portion of the flat profile is disposed widthwise, whether or not previously incised, said jaws being disposed in pairs at different positions to come into contact on different portions of the width of the blade, the pairs of jaws being offset from each other so as to reproduce the gap of the slats, said jaws adopting a profile with at least one spiral, the difference in radius between the beginning and the end of the spiral forming a planar step ensuring deformation of the planar portions of the slats to form the braces.
